(19) United States
(12) Patent Application Publication
(10) Pub. No.: US 2016/0285843 A1
(43) Pub. Date: Sep. 29, 2016

(54) SYSTEM AND METHOD FOR SCOPING A USER IDENTITY ASSERTION TO COLLABORATIVE DEVICES

(71) Applicant: MOTOROLA SOLUTIONS, INC, SCHAUMBURG, IL (US)

(72) Inventors: GEORGE POPOVICH, PALATINE, IL (US); ADAM C. LEWIS, Buffalo Grvoe, IL (US); ANTHONY R. METKE, NAPERVILLE, IL (US); STEVEN D. UPP, BARTLETT, IL (US)

(21) Appl. No.: 14/671,244

(22) Filed: Mar. 27, 2015

(51) Int. Cl. H04L 29/06

(52) U.S. Cl. CPC H04L 63/08

(57) ABSTRACT

A system and method for enabling a primary and a secondary communication device to share a user identity assertion is presented. The user identity assertion enables the devices to access an application system. The primary and secondary devices are paired to place them in collaboration with each other. The primary device requests an identity provider system to issue a user identity assertion scoped to the primary and secondary communication device. The identity provider system authenticates the primary device and generates the user identity assertion scoped to the primary device and the secondary device identified in the request. The primary communication device receives the user identity assertion and communicates the user identity assertion to the secondary device. The primary device may request the user identity assertion by communicating a user identity assertion scoped to the primary device and a single sign on session cookie or a request for an extension assertion.

### REFERENCE TO RELATED APPLICATIONS

The present application is related to U.S. patent application Ser. No. 13/728,752, attorney docket no. CM15610, entitled System and Method for Scoping a User identity assertion to Collaborative Devices, priority to which is claimed.

### BACKGROUND

Many computer systems handle sensitive, proprietary and private information, and applications (collectively referred to herein as “applications”). These applications may include data access, computer programs, applications and services. In order to limit access to such applications, access to the computer system may be limited to authorized users. Further, as many computer systems host a variety of application services, authorized users may be granted access to only a subset of these applications.

Such security measures may be achieved through the use of identity and access management (“IdM”) solutions. Examples of IdM solutions include the Security Assertion Markup Language (“SAML”) and the open standard for authorization (“OAuth”). SAML is an XML based open standard for exchanging authentication and authorization data between security domains. In the SAML standard, the user enrolls with an identity provider. For example, the user may provide the identity provider with information about the user, such as the user's name, email address and/or other such information. The identity provider authenticates the identity of the user (“primary authentication”). To indicate the user has been authenticated by the identity provider, the identity provider communicates a user identity assertion to the user. For example, the user identity assertion may be included in a token. When the user attempts to access the computer system, the user identity assertion is communicated with the computer system. The computer system relies on the user identity assertion provided by the identity provider to authenticate the user and the extent to which the user may access the computer system. OAuth is an open standard that enables the communication of user identity assertions between entities. For example, OAuth enables programs and/or applications to access data from one another.

As users generally access the computer system via one or more of some type of electronic communication device, such as a computer or cellular phone, the user identity assertion may be communicated to the user's first communication device. It would be advantageous if all of the user's devices can have access to the applications with the use of the same user identity assertion.

### BRIEF DESCRIPTION OF THE DRAWINGS

In the accompanying figures, like reference numerals refer to identical or functionally similar elements throughout the separate views.

FIG. 1 is a block diagram of an exemplary identity management system.

FIG. 2 is a block diagram of an exemplary identity provider system.

FIG. 3 is a block diagram of an exemplary primary communication device.

FIG. 4 is a block diagram of an exemplary secondary communication device.

FIG. 5 is a block diagram of an exemplary application system.

FIG. 6 is a swim lane diagram of a first exemplary method for sharing a user identity assertion between primary and secondary communication devices.

FIG. 7 is a swim lane diagram of a second exemplary method for sharing a user identity assertion between primary and secondary communication devices.

FIG. 8 is a block diagram of a user identity assertion.

Elements in the figures are illustrated for simplicity and clarity and have not necessarily been drawn to scale. For example, the dimensions of some of the elements in the figures may be exaggerated relative to other elements. Further, the apparatus and method components have been represented, where appropriate, by conventional symbols in the drawings.

### DETAILED DESCRIPTION

An example of method for sharing a user identity assertion between a primary communication device and a secondary communication device (the “sharing method”), wherein the user identity assertion enables the primary and secondary communication devices to access an application system is disclosed. The sharing method generally includes pairing the primary and secondary communication devices; communicating a request for a user identity assertion scoped to the primary and secondary communication devices from the primary communication device to an identity provider system; receiving the user identity assertion scoped to the primary and secondary communication devices from the identity provider system by the primary communication device; and communicating the user identity assertion scoped to the primary and secondary communication devices from the primary communication device to the secondary communication device. The user identity assertion may be implemented in an identity token. This token will be “bound” to particular users of the token. For example, the contents of the identity token “bind” or associate the identity of one or more users to a set of privileges and attributes. The token is then digitally signed by the IdM issuing party to prevent token alteration.

In addition to being “bound” to user(s), as the assertion is also scoped to those users. The term “scoping” the assertion to two or more devices is intended to mean that the issued assertion explicitly contains the identities of the two or more devices that are authorized to utilize the assertion for future authentication to service providers. The identities included within the assertion (token) include names, DNS names, public keys, network addresses, device serial numbers, MAC addresses, or any administratively assigned device name, or a function or hashes based on of the devices' public key, device certificate fields, or any combination of the above.

In addition to the identities of each device, in a second embodiment of the present invention, “scoping” is also meant to encompass allowed device capabilities for each device identified within the user identity assertion. For example, an authorization level granted for each device can be different, and specifically identified within the identity token. In other words, one device may be granted a different authorization level than another device. The authorization level may include an assertion expiration period for each device along with specific applications that are allowed to be accessed by each device.

In yet another embodiment of the present invention, “scoping” is meant to encompass an assurance, or trust level for each device within the user identity assertion. In other words, a first device may be a higher assurance device than a second device, with, for example, hardware backed security mechanisms and additional operating system and software hardening, which could be interpreted by the an issuer of the user identity assertion as being more trustworthy and less likely to be compromised (e.g. by malware). As a result, the assertion issuer can label the device in the assertion as one that has been vetted as being a higher assurance device. Also as a result, an application server, when enforcing the privilege rules, might extend additional privileges to the user if the user's device is one of these higher assurance devices.

The assertion issuer can vet the device as a higher assurance device by well known means, such as having the device prove possession of a credential that is only issued to hardware security modules, for example. In one embodiment the nodes of a PAN (personal area network—e.g. 2 or more collaborative devices) securely verify each other's assurance level, and the highest assurance level device requests the user assertion with the issuer, and the device asserts the assurance level of the devices to the issuer. The issuer determines authorization attributes for the user for each device.

In one embodiment any device can request an assertion from an identity-assertion issuer without specifying an assurance level. The issuer will include an authorization attribute for each device type or device assurance level. It is then up to the application server to determine the device assurance level.

For application of the invention to dual persona (dual use) devices such as smart phones, we view this as the inverse of the concept of multiple collaborative devices forming a “virtual device”. In other words, one physical device could be viewed as two virtual devices (the two personas), each having an user identity assertion scoped to it.

In one example, the sharing method may also include communicating a request for a user identity assertion scoped to the primary communication device to the identity provider system from the primary communication device. The step of communicating the request for the user identity assertion scoped to the primary and secondary communication devices to the identity provider system may include communicating the user identity assertion scoped to the primary device and a single sign on session cookie from the primary communication device to the identity provider system and/or communicating the user identity assertion scoped to the primary communication device and a request for an extension assertion from the primary communication device to the identity provider system. The user identity assertion scoped to the primary and secondary communication devices may include the user identity assertion scoped to the primary communication device and the extension assertion.

In one example, the step of pairing the primary and secondary communication devices is performed after the step of communicating the request for the user identity assertion scoped to the primary communication device from the primary communication device to the identity provider system. In another example, the step of pairing the primary and secondary communication devices is performed before the step of communicating the request for the user identity assertion scoped to the primary and secondary communication devices to the identity provider system from the primary communication device.

The step of communicating the request for the user identity assertion to the identity provider system from the primary communication device may include communicating a primary communication device identifier and/or communicating a secondary communication device identifier to the identity provider system.

A method for issuing a user identity assertion scoped to one or more communication devices, wherein the user identity assertion enables the one or more communication devices to access an application system is disclosed (an “issuing method”). The issuing method may include, receiving a request for the user identity assertion scoped to one or more communication devices from a first of the one or more communication devices, wherein the one or more communication devices are paired with each other; authenticating the first communication device; generating the user identity assertion scoped to the one or more communication devices and communicating the user identity assertion scoped to the one or more communication devices to the first of the one or more communication devices, wherein the first of the one or more communication devices is configured to communicate the user identity assertion scoped to the one or more communication devices to the one or more communication devices.

The term “pairing” is specifically meant to include, but not be limited to a Bluetooth pairing (e.g., pairing can also be accomplished by creating a connection between two or more devices over a Wireless LAN interface). Such a pairing uses a method called bonding for recognizing specific devices and thus enabling control over which devices are allowed to connect to each other. Devices then can establish a connection without user intervention. A bond is created through a process called “pairing”. The pairing process is typically triggered by a specific request to create a bond from a user via a user interface.

Pairing typically involves some level of user interaction (e.g., providing a common password among devices). This user interaction is the basis for assuring the identity of devices. Once pairing successfully completes (i.e., once devices are paired), a bond will have been formed between the two devices, enabling those two devices to connect to each other in the future without again requiring the pairing process. When desired, the bonding relationship can later be removed by the user. Data can then be exchanged among the paired devices. In one embodiment of the present invention, an user identity assertion is only passed from a primary device to a secondary device when the devices are paired, and each paired device is included within the scoped user identity assertion.

A system for sharing a user identity assertion between a primary communication device and a secondary communication device (a “sharing system”), which can be implemented within an apparatus, wherein the user identity assertion enables the primary and secondary communication devices to access an application system is disclosed. The sharing system generally includes, a collaboration module configured to pair the primary and secondary communication devices; a request module configured to generate a request for the user identity assertion scoped to the primary and secondary communication devices; a first interface configured to communicate the request for the user identity assertion scoped to the primary and secondary communication devices to an identity provider system and further configured to receive the user identity assertion scoped to the primary and secondary communication devices from the identity provider system and a second interface configured to communicate the user identity assertion scoped to the primary and secondary communication devices to the secondary communication device. In one example of the sharing system, the user identity assertion scoped to the primary and secondary communication devices is configured to enable the secondary device to access an application system. The user identity assertion may include an identity token.

The request module may be further configured to generate a request for a user identity assertion scoped to the primary communication device. The request for the user identity assertion scoped to the primary and secondary communication devices may include the user identity assertion scoped to the primary device and a single sign on session cookie and/or the user identity assertion scoped to the primary communication device and a request for an extension assertion. In one example, the user identity assertion scoped to the primary and secondary communication devices includes the user identity assertion scoped to the primary communication device and the extension assertion.

In one example, the collaboration module is further configured to pair the primary and secondary communication devices after the first interface communicates the request for the user identity assertion scoped to the primary communication device to the identity provider system. In another example, the collaboration module is further configured to pair the primary and secondary communication devices before the first interface communicates the request for the user identity assertion scoped to the primary and secondary communication devices to the identity provider system.

The first interface may be further configured to communicate a primary communication device identifier and/or communicate a secondary communication device identifier to the identity provider system.

A system for issuing a user identity assertion scoped to one or more communication devices, wherein the user identity assertion enables the one or more communication devices to access an application device (an “issuing system”) is disclosed. The issuing system generally includes, an interface configured to receive a request for the user identity assertion scoped to one or more communication devices from a first of the one or more communication device, wherein the one or more communication devices are in paired with each other; an authentication module configured to authenticate the first one of the communication devices and an assertion module configured to generate the user identity assertion scoped to the one or more communication devices, wherein the interface is further configured to communicate the user identity assertion scoped to the one or more communication devices to the first of the one of the communication devices and wherein the first of the one or more communication devices is configured to communicate the user identity assertion scoped to the one or more communication devices to the one or more communication devices.

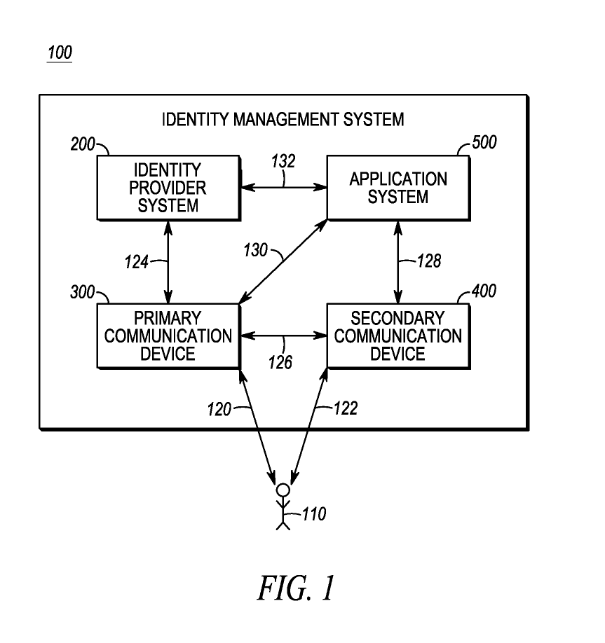

FIG. 1 depicts an example of an identity management system 100. The identity management system 100 generally includes an identity provider system 200, a primary communication device (“primary device”) 300, a secondary communication device (“secondary device”) 400 and an application system 500. This identity management system 100 enables an entity or individual (a “user”) 110 to access computer programs, applications, information and services hosted by the application system 500 via the primary communication device 300 and the secondary communication device 400 using a shared user identity assertion. Thus, the user 110 may access the application system 500 via the secondary communication device 400 without having to perform primary authentication with the identity provider system 200.

In the exemplary identity management system 100, all the devices through which the user is to access the application system 500 are placed in a state of collaboration with each other. This may be accomplished by establishing a security association among the devices (e.g., Bluetooth pairing). When such association is established, the devices are said to be “paired.” For example, a primary communication device 300 may be paired with a secondary device 400. When the user 110 is authenticated via the primary communication device 300, the identity provider system 200 communicates a user identity assertion to the primary communication device 300. The collaboration between the primary and secondary communication devices 300 and 400, respectively, enables the primary communication device 300 to communicate (share) the user identity assertion with the secondary communication device 400. It should be noted that the primary user device will only share the user identity assertion with the secondary user device if the user identity assertion is scoped to both the primary and the secondary devices.

Although FIG. 1 depicts an example of the identity management system 100 that includes one secondary device 400, other examples of an identity management system 100 may include any number of secondary devices, all of which may be paired with the other secondary devices and the primary device 300. In this manner, the primary device 300 may share the user identity assertion with any number of secondary devices.

When used in the context of a single sign on (“SSO”) session, the identity management system 100 may enable the duration of a user identity assertion to be different than that of the SSO session. As mentioned above, the “duration” for each device may be included within the user identity assertion. For example, a user identity assertion may have a duration shorter than that of an SSO session. This may provide added security by limiting the time frame during which the user identity assertion may be abused. In this example, when a user identity assertion has expired, a new one must be provided. However, if the new user identity assertion is requested during the SSO session, the user does not need to perform primary authentication again.

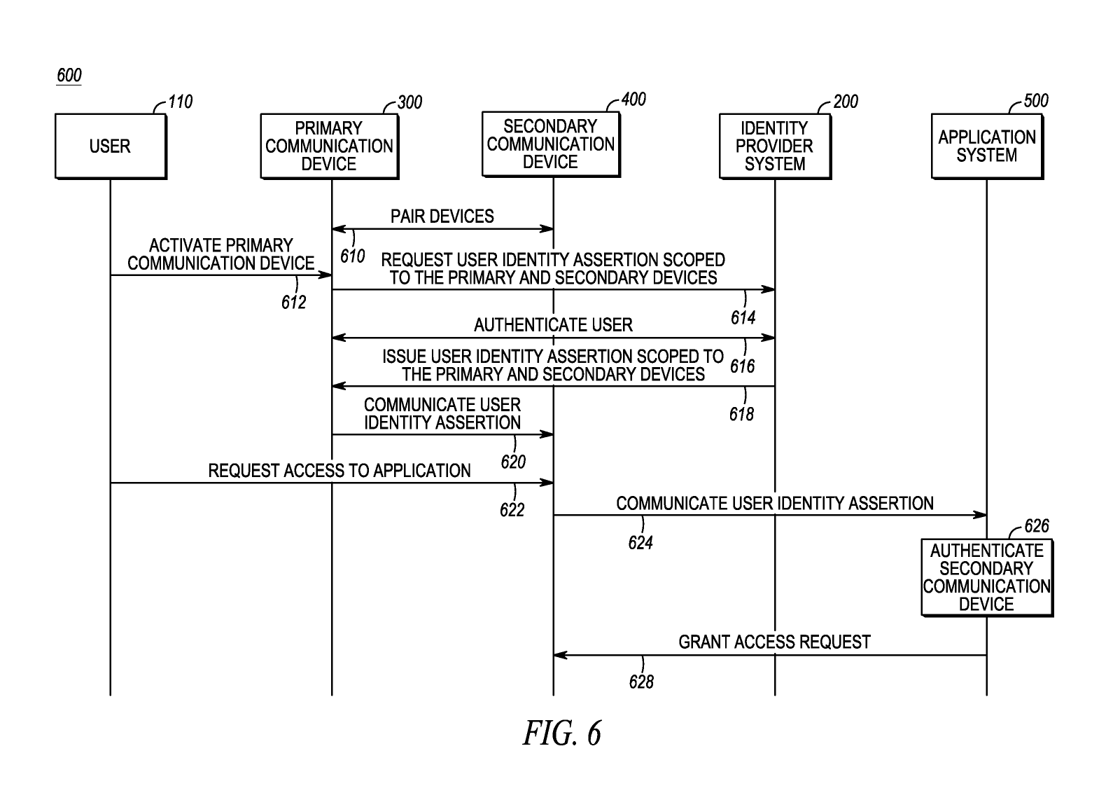

The duration is enforced by the application system during step 626 of FIG. 6. The application system reads the duration set in the assertion and only considers the assertion valid if the duration has not yet expired. Thus the application system is the enforcing point for determining the validity and privileges associated with the ID assertion.

As shown in FIG. 1, the identity provider system 200, primary device 300, secondary device 400 and application system 500 are in communication with each other via communications paths 120, 122, 124, 126, 128, 130 and 132. Communications paths 120, 122, 124, 126, 128, 130 and 132 may traverse one or more communications systems that include, alone or in combination, wired and/or wireless communication technologies. Examples of wired communication technologies include, but are not limited to twisted pair wire, coaxial cable and optical cable. Examples of wireless communication technologies include, but are not limited to, terrestrial microwave, communication satellites, cellular systems, PCS systems, wireless local area networks (WLAN), infrared communications, Bluetooth, and global area networks (GAN). These technologies may form one or more networks over which the components of the identity management system 100 communicate with each other and with the user 110.

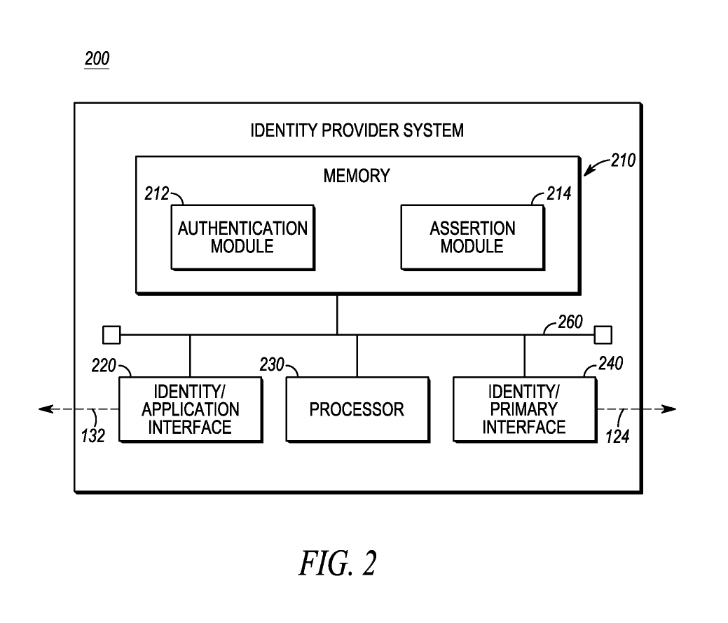

The identity provider system 200, primary communication device 300, secondary communication device 400 and application system 500 are shown in FIGS. 2, 3, 4 and 5 respectively. With reference to FIGS. 2, 3, 4 and 5, the identity provider system 200, primary communication device 300, secondary communication device 400 and application system 500 each generally include a processor 230, 330, 430 and 530, respectively. Processors 230, 330, 430 and 530 include one or more devices capable of processing digital information, such as a microprocessor. The processors 230, 330, 430 and 530 may be implemented as shown in FIGS. 2, 3, 4 and 5. However, the processors 230, 330, 430 and 530 may be implemented in one or more devices located in, near and/or remote from the identity provider system 200, primary communication device 300, secondary communication device 400, and/or application system 500.

The identity provider system 200, primary communication device 300, secondary communication device 400 and application system 500 each generally include a memory 210, 310, 410 and 510, respectively. Memory 510 includes an application database 512. Memories 210, 310, 410, 510 and database 512 include any device or devices capable of storing computer readable instructions and/or data. Memories 210, 310, 410, 510 and database 512 may include magnetic media like a floppy disk that may be read by a floppy disk drive, a hard disk drive and magnetic tape; optical media like a Compact Disc (CD), a Digital Video Disk (DVD), a Blu-ray Disc, which may be read by an optical disk drive; and solid state memory such as random access memory (RAM), flash memory, and read only memory (ROM). The memories 210, 310, 410, 510 and database 512 may be implemented as shown in FIGS. 2, 3, 4 and 5. However, the memories may be implemented in one or more devices located in, near and/or remote from the identity provider system 200, primary communication device 300, secondary communication device 400 and/or application system 500.

The identity provider system 200 may include an authentication module 212 and an assertion module 214 stored in memory 210. The primary communication device 300 may include a collaboration module 312 and a request module 314 stored in memory 310. The secondary communication device 400 may include a collaboration module 412 stored in memory 410. The application system 500 may include a verification module 514 stored in memory 510. Modules 212, 214, 312, 314, 412 and 514 may include computer executable software. Alternatively, modules 212, 214, 312, 314,412 and 514 may be implemented apart from memories 210, 310, 410 and 510, respectively. In this case, the modules 212, 214, 312, 314, 412 and 514 may include separate devices, which may include a processor and/or memory in which the computer readable software is stored.

The identity provider system 200, primary communication device 300, secondary communication device 400 and the application system 500 each generally include one or more interfaces. The identity provider system 200 may include an identity/primary interface 240. The identity provider system 200 may also include an identity/application interface 220. Alternately, the identity/primary interface 240 and the identity/application interface 220 may be implemented in a single interface. The primary communication device 300 may include a secondary device interface 380, a primary/identity interface 370, a primary/application interface 320 and a user interface 350. The secondary device interface 380, primary/application interface 320, primary/identity interface 370 and user interface 350 may be implemented in one or more interfaces in any combination. The secondary communication device 400 may include a primary device interface 480, a secondary/application interface 420, and a user interface 450. The primary device interface 480 and the secondary/application interface 420 may be implemented in a single interface. The application system 500 may include a device interface 540 and/or an application/identity interface 570. The device interface 540 and the application/identity interface 570 may be implemented in a single interface. These interfaces 220, 240, 320, 350, 370, 380, 420, 450, 480, 540 and 570 include input and output devices and computer executable software that enable the identity provider system 200, primary communication device 300, secondary communication device 400 and application system 500 to communicate with each other via communication paths 120, 122, 124, 126, 128 130 and 132.

The interfaces 220, 240, 320, 350, 370, 380, 420, 450, 480, 540 and 570 generally include devices and/or software capable of generating, transmitting and receiving electrical and/or electromagnetic signals. For example, the interfaces 220, 240, 320, 350, 370, 380, 420, 450, 480, 540 and 570 may include a wired device, such as a modem and/or a wireless device, such as a radio. The radio may communicate according to various communications protocols such as, WiMAX™, 802.11 a/b/g/n, Bluetooth™, 2G, 3G, and 4G.

The identity provider system 200, primary communication device 300, secondary communication device 400 and the application system 500 each generally include a bus 260, 360, 460 and 560, respectively. The buses 260, 360, 460 and 560 include a subsystem that transfers data between the components of the identity provider system 200, primary communication device 300, secondary communication device 400 and the application system 500, respectively.

As shown in FIG. 2, the identity provider system 200 may include memory 210, identity/application interface 220, processor 230, identity/primary interface 240 and bus 260. The identity provider system 200 may be implemented in one or more servers. The identity/application interface 220 enables the identity provider system 200 to communicate with the application system 500 via communication path 132. The identity/primary interface 240 enables the identity provider system 200 to communicate with the primary device 300 via communication path 124.

The memory 210 may include an authentication module 212 and an assertion module 214. The authentication module 212 is configured to authenticate the identity of the user 110 via the primary device 300 in response to a request for a user identity assertion from the primary device 300. The assertion module 214 is configured to generate a user identity assertion as a function of the request from the primary device 300. The memory 210 may store user identity assertions and the corresponding users and devices.

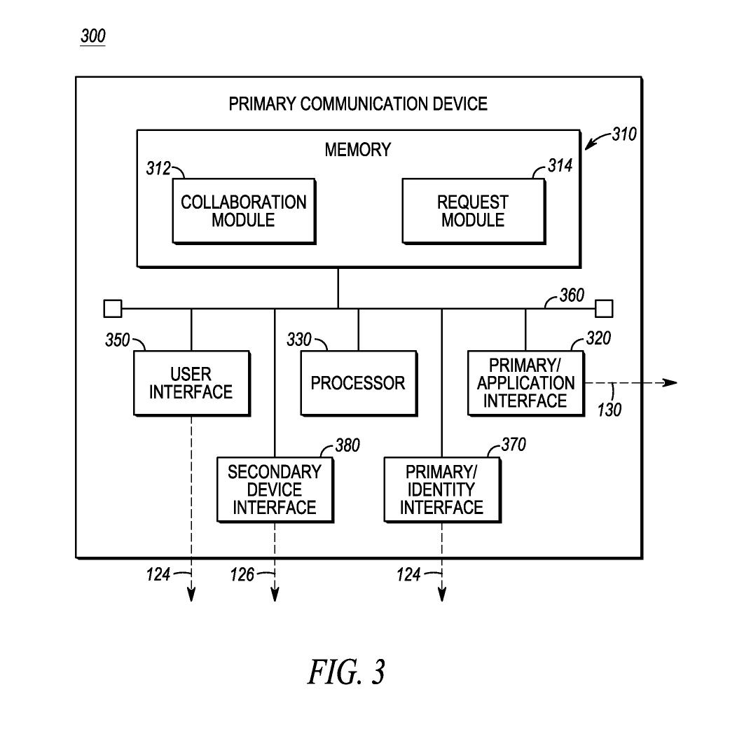

As shown in FIG. 3, the primary communication device 300 may include a memory 310, primary/application interface 320, processor 330, user interface 350, primary/identity interface 370, secondary device interface 380 and bus 360. The user interface 350 enables the primary device 300 to communicate with the user 110 via communication path 120. The primary/identity interface 370 enables the primary device 300 to communicate with the identity provider system 200 via communication path 124. The primary/application interface 320 enables the primary device 300 to communicate with the application system 500 via communication path 130. The secondary interface 380 enables the primary device 300 to communicate with the secondary device 400 via communication path 126.

The memory 310 may include a collaboration module 312 and a request module 314. The collaboration module 312 is configured to place the primary device 300 in collaboration (i.e. pair) with the secondary device 400. The request module 314 is configured to generate a request for a user authentication assertion. The memory 310 may store user identity assertions and the identification of collaborating devices.

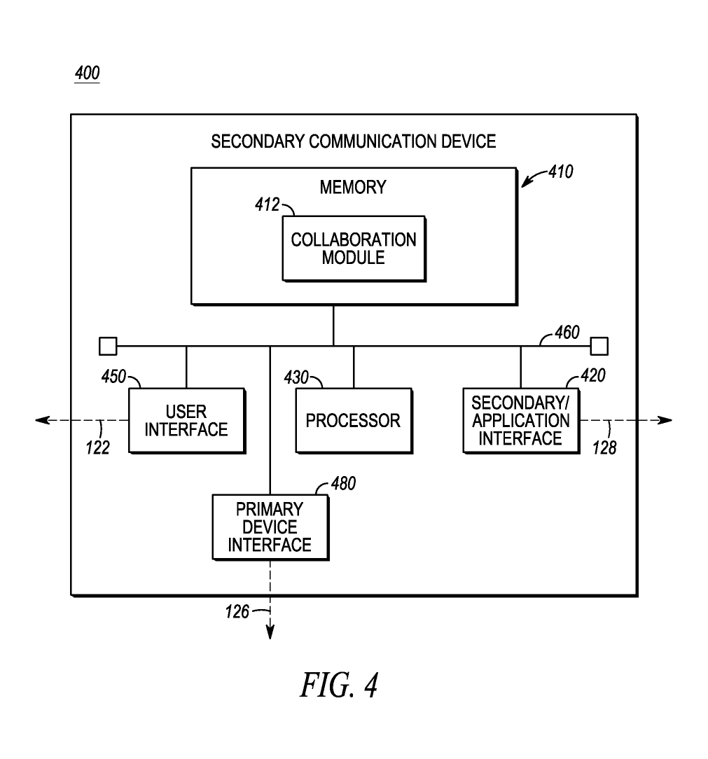

As shown in FIG. 4, the secondary communication device 400 may include a memory 410, secondary/application interface 420, processor 430, user interface 450, primary device interface 480 and bus 460. The secondary/application interface 420 enables the secondary device 400 to communicate with the application system 500 via communication path 128. The primary device interface 480 enables the secondary device 400 to communicate with the primary device 300 via communication path 126. The user interface 450 enables the secondary device 400 to communicate with the user 110 via communication path 122.

The memory 410 may include a collaboration module 412. The collaboration module 412 is configured to place the secondary device 400 in collaboration (i.e. pair) with the primary device 300. The memory 410 may store user identity assertions and the identification of collaborating devices.

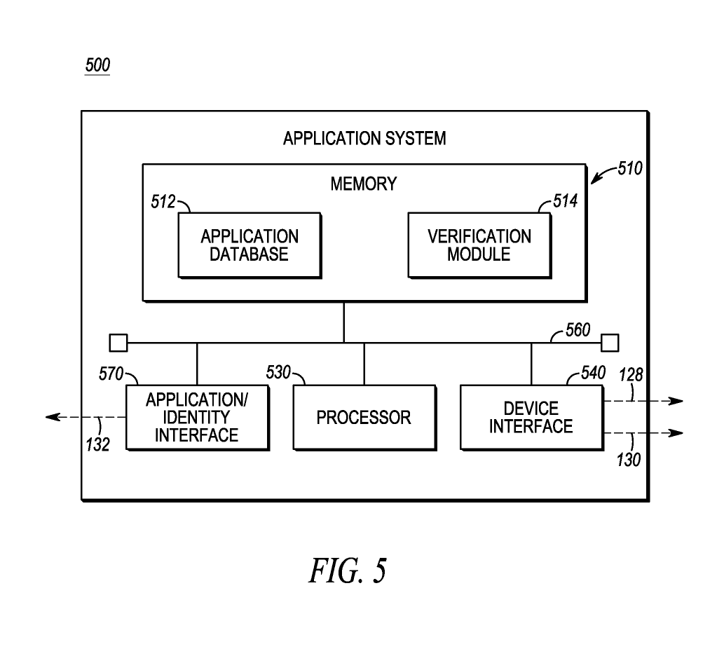

As shown in FIG. 5, the application system 500 may include a memory 510, application/identity interface 570, processor 530, device interface 540 and bus 560. The application system 500 may be implemented in one or more servers. Application/identity interface 570 enables the application system 500 to communicate with the identity provider system 200 via communication path 132. The device interface 540 enables the application system 500 to communicate with the primary device 300 and the secondary device 400 via communication paths 130 and 128, respectively.

The memory 510 may include an application database 512 and a verification module 514. The application database 512 includes one or more computer programs, applications, data, information and services that may be accessed by an authorized user via the primary and secondary devices 300 and 400, respectively, according to the user identity assertion. The verification module 514 is configured to authenticate the identity of the user 110 via the primary device 300 or secondary device 400 in response to a request for access to one or more of the applications, information and services hosted by the application system 500.

FIG. 6, with reference to FIG. 3, depicts a first example of a method for sharing a user identity assertion between primary and secondary communication devices (“sharing method 600”). In step 610, the primary and secondary device 300 and 400, respectively, are paired with each other. This may be accomplished via mutual authentication in which the devices 300 and 400 communicate each device's unique, immutable device identification to each other. This mutual authentication may occur between the primary device 300 and any number of secondary devices.

In step 612, the user 110, or an entity or electronic device, activates the primary device 300 by communicating the user credentials to the primary device 300. Activation of the primary device 300 may be accomplished by turning the primary device on or otherwise interacting with the primary device 300. The user 110 may follow commands presented to the user 110 via the user interface 350. The user 110 may access the primary device by direct or remote interaction with the primary device 300.

Activation of the primary device 300 may trigger the primary device 300 to communicate a request for a user identity assertion applicable to the primary and secondary devices 300 and 400, respectively, to the identity provider system 200. The request generally includes the device identification of the primary and secondary devices, 300 and 400, respectively, in step 614.

In step 616, the identity provider system 200 authenticates the identity of the user 110 via the primary device 300, for example, over a transport-layer security (TLS) connection. The primary device 300 communicates the device identification of the secondary device 400 to the identity provider system 200. In response, as shown in step 618, the identity provider system 200 issues, to the primary device 300, a user identity assertion scoped to the primary 300 and secondary 400 devices and may include one or more privileges granted to the primary device 300 and the secondary device 400. The user identity assertion may be implemented in an identity token. In other words, the user identity assertion is “scoped” to the primary device 300 and the secondary device 400. The devices and privileges to which the user identity assertion may apply may be determined according to parameters specified by the application system 500 and may include the computer programs, applications, data, and services to which the user has access. Alternately, the device identification for the secondary device 400 may be communicated in a separate communication. In this case, the identity provider system 200 may append the device identification of the secondary device 400. To provide further authentication, the identity provider system 200 may communicate a message, also referred to as a challenge, to the primary communication device 300. The challenge may include, for example, a timestamp or a random number that requires the primary device 300 and the secondary device 400 to digitally sign the challenge and communicate the signature back to the identity provider system 2 via the primary communication device 300.

In step 620, the primary device 300 communicates the user identity assertion with the secondary device 400.

As depicted in step 622, the user 110 requests access to the application system 500 or any of the computer programs, applications, information or services the application system 500 hosts, via the secondary device 400. The user 110 may make this request by launching an application on the secondary device 400. The secondary device 400 may then request access by communicating the user identity assertion to the application system 500 without the need for primary authentication in step 624. In addition, the secondary device 400 may communicate a device credential, such as a public key certificate or shared secret.

Upon receiving an access request from the secondary device 400, the application system 500 generally authenticates the secondary device 400, as shown in step 626. This may include the application system 500 verifying that the secondary device 400 is within the scope of the user identity assertion, the user identity assertion has not been modified and/or the user identity assertion was generated by a trusted identity provider system 200 and/or the validity of the secondary device's credential. The authentication may be performed over a TLS connection. If the application system 500 authenticates the secondary device 400, at step 628, the user 110 is granted access via the secondary device 400 to the computer programs, applications, information or services specified in user identity assertion.

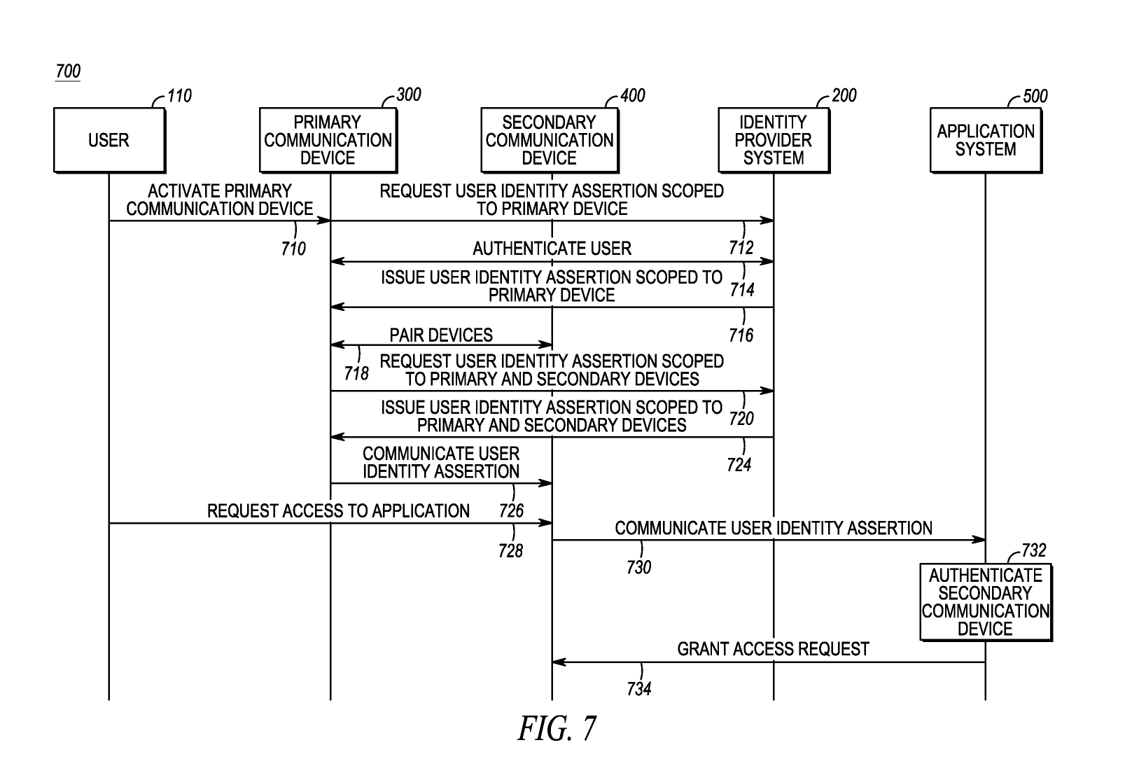

FIG. 7 depicts a second example of a method for sharing a user identity assertion between primary and secondary communication devices (“sharing method 700”). With reference to FIG. 3 the user 110, or an entity or electronic device, activates the primary device 300 by communicating the user credentials to the primary device 300 in step 710. Activation of the primary device 300 may be accomplished by turning the primary device 300 on or otherwise interacting with the primary device 300. The user 110 may follow commands presented to the user 110 via the user interface 350. The user 110 may access the primary device 300 by direct or remote interaction with the primary device 300.

Activation of the primary device 300 may trigger the primary device 300 to communicate a request for a user identity assertion applicable to the primary device 300 to the identity provider system 200 in step 712. The request generally includes the device identification of the primary device 300 in step 714.

In step 714, the identity provider system 200 authenticates the identity of the user 110 via the primary device 300. In response, as shown in step 716, the identity provider system 200 issues a user identity assertion applicable to the primary device 300 and may include one or more privileges granted to the primary device 300. In other words, the user identity assertion is “scoped” to the primary device 300. The privileges to which the user identity assertion may apply may be determined according to parameters specified by the application system 500.

In step 718, the primary and secondary devices 300 and 400, respectively, are paired with each other. This may be accomplished via mutual authentication in which the devices 300 and 400 communicate each device's unique, immutable device identification to each other. This mutual authentication can occur between the primary device 300 and any number of secondary devices.

In step 720, the primary device 300 may communicate a request for a user identity assertion applicable to the primary and secondary devices 300 and 400, respectively, to the identity provider system 200. The primary device 300 communicates the device identification of the secondary device 400 to the identity provider system 200. In response, as shown in step 724, the identity provider system 200 issues, to the primary device 300, a user identity assertion scoped to the primary 300 and secondary 400 devices. It should be noted that if privileges are included within the user identity assertion, these privileges may differ for the primary and secondary devices. The user identity assertion may be implemented in an identity token. The devices and privileges to which the user identity assertion may apply may be determined according to parameters specified by the application system 500.

In step 726, the primary device 300 communicates the user identity assertion with the secondary device 400.

As depicted in step 728, the user 110 requests access to the application system 500 or any of the computer programs, applications, information or services the application system 500 hosts via, the secondary device 400. The user 110 may make this request by launching one of the computer programs, applications, information or services on the secondary device 400. The secondary device 400 may then request access by communicating the user identity assertion to the application system 500 without the need for primary authentication in step 730. In addition, the secondary device 400 may communicate a device credential, such as a public key certificate or shared secret.

Upon receiving an access request from the secondary device 400, the application system 500 generally authenticates the secondary device 400, as shown in step 732. This may include the application system 500 verifying that the secondary device 400 is within the scope of the user identity assertion, the user identity assertion has not been modified, the user identity assertion was generated by a trusted identity provider system 200 and/or the validity of the secondary device's credential. If the application system 500 authenticates the secondary device 400, the user 110 is granted access to the computer programs, applications, information or services as specified in the user identity assertion in step 734.

In another embodiment of the sharing system 700, in step 720, the request for the user identity assertion scoped to the primary and secondary devices 300 and 400, respectively, may include the identity provider system 200 authenticating the primary device 300 again. However, if during a valid single sign on (“SSO”) window time frame, the user identity assertion scoped to the primary device 300 and/or the SSO session cookie may be with the identity provider system 200 and the primary device 300 need not be authenticated again. In another embodiment of the sharing system 700, in step 720, the request for the user identity assertion scoped to the primary and secondary devices 300 and 400, respectively, may include the primary device 300 communicating the user identity assertion scoped to the primary device 300 and a request for an extension assertion to the identity provider system 200. The extension assertion and the user identity assertion scoped to the primary device 300 are communicated with the secondary device 400.

In the sharing methods 600 and 700, the user identity assertion may have a limited duration (time to live) and, thus, the collaboration may need to be renewed and reauthorized periodically. In addition, the sharing methods 600 and 700 may further include terminating the collaboration. For example, the primary and/or secondary devices 300 and 400, respectively, may need to be authorized for another user. In another example, if the primary and/or secondary devices 300 and 400, respectively, are lost or stolen, the authorization for the lost or stolen device needs to be revoked to avoid compromise of sensitive information.

Referring to FIG. 1, the identity management system 100 may be applied to public safety systems. These public safety systems support the operation of law enforcement, emergency response and firefighting services. Public safety systems may include an application system 500, such as that shown in FIG. 1. The application system500 may host one or more applications and/or databases for use by the individuals and entities involved in providing these services. For example, such services may include location information and tracking, messaging, crime database access, computer-aided dispatch (“CAD”), video monitoring and mission critical voice communications.

The individuals and entities are becoming more reliant on multiple communication devices for various types of communications. In some cases, the individuals and entities may use their own communication devices (Bring Your Own Device (BYOD)) for providing these services. The multiple communication devices may be placed into a state of collaboration among each other. Configurations of these collaborations may be in the form of one-to-one, one-to-many and many-many. Implementing a version of the identity management system 100 combined with the collaboration among devices enables authorized individuals and/or entities to access the application system 500 via any of the individual's and/or entity's approved, collaborated devices, without the need for primary authentication of each secondary collaborating device.

Public safety systems provide but one example of an implementation of the identity management system 100. The identity management system 100 may be implemented in a variety of other circumstances and systems.

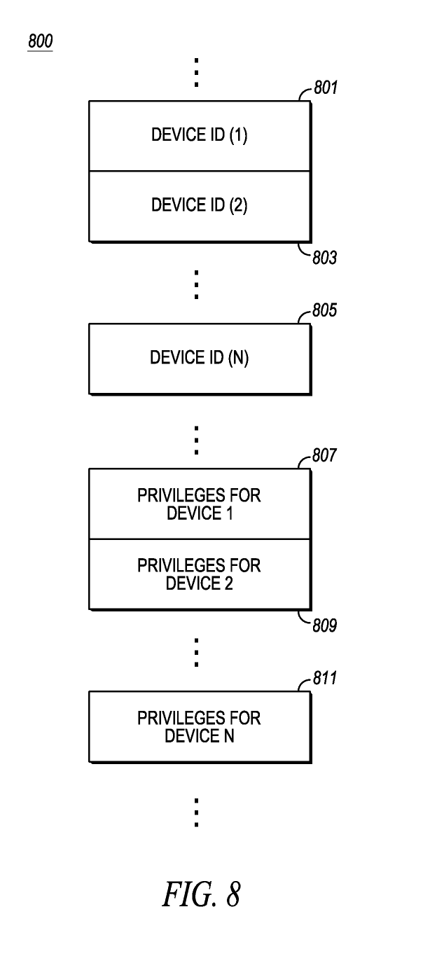

FIG. 8 is a block diagram of an user identity assertion. The user identity assertion may be implemented as a file containing information needed to access application system 500. It is worth noting that in the preferred embodiment of the present invention, the user identity assertion is not a mere “license” that is shared among devices. The user identity assertion comprises the IDs of devices, and privileges for those devices, and in some embodiments of the present invention, must be provided to any system where the device wishes to gain access. The IDs may comprise an “authentication context” to gain access to any system. Such an authentication context may comprise any of the following:
a unique identifier corresponding to the human user (e.g. a “coreID”);
possibly other attributes corresponding to the human user (e.g. certifications, roles, contact information, employment agency, etc.);
the time at which the user authenticated in order to obtain authentication context record;
the method by which the user authenticated in order to obtain the authentication context record (e.g. password, RSA, smartcard, etc.);
the time at which the authentication context record was issued;
the time at which the authentication context record expires;
the time before which the authentication context record must not be accepted.

User identity assertion 800 may be implemented as an identity token, or a single-sign-on session cookie. As shown, user identity assertion 800 comprises identities for devices for which the user identity assertion is scoped. So for example, user identity assertion 800 comprises an identification 801 for a first device, and identification for a second device 803, and at least an user identity assertion for a third device 805.

As mentioned above the identifications 801-803 preferably comprise names, DNS names, public keys, network addresses, device serial numbers, MAC addresses, or any administratively assigned device name, or a function or hashes based on of the devices' public key, or any combination of the above.

In addition to identities 801-805, the user identity assertion 800 may optionally comprise privileges 807-811 for each device identified within assertion 800. These privileges 807-811 may be similar, or different from each other. As discussed above, these privileges may comprise privileges such as, but not limited to the computer programs, applications, data, and services to which the user has access (in any combination). In addition, privileges 807-811 may additionally comprise a time-to-live (TTL) for the user identity assertion, as it applies to each device. So, for example, a first device may have a first TTL, while a second device may have a second TTL. These TTLs may differ.

Enforcement, of the device privileges and TTL values is performed by the application system 500, in steps 626 and 732. Upon receipt of the user identity assertion (624 or 730), the application system may read the privileges and TTL values from the assertion and determine if access should be granted, and the appropriate level of authorization to be granted to the user, based on the application system's authorization policy. In the case of TTL enforcement, the application system may verify that the TTL for the device in question is still valid. If it is expired, then the application system may deny access to the combination of the user and specific device in question.

In the foregoing specification, specific embodiments have been described. However, various modifications and changes can be made without departing from the scope of the claims herein. For example, method steps are not necessarily performed in the order described or depicted, unless such order is specifically indicated. Accordingly, the specification and figures are to be regarded in an illustrative rather than a restrictive sense, and all such modifications are intended to be included within the scope of the claims.

It will be appreciated that some embodiments may be comprised of one or more generic or specialized processors such as microprocessors, digital signal processors, customized processors and field programmable gate arrays (“FPGAs”) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

We claim:

1. A method for sharing a user identity assertion between a primary communication device and a secondary communication device, wherein the user identity assertion enables the primary and secondary communication devices to access an application system, comprising:
pairing the primary and secondary communication devices;
communicating a request for a user identity assertion scoped to the primary and secondary communication devices from the primary communication device to an identity provider system;
receiving the user identity assertion scoped to the primary and secondary communication devices from the identity provider system by the primary communication device;
communicating the user identity assertion scoped to the primary and secondary communication devices from the primary communication device to the secondary communication device; and
wherein the user identity assertion comprises an identification of the primary and the secondary communication devices, and also comprises a trust level for the primary and the secondary communication devices.

2. The method of claim 1 further comprising communicating a request for a user identity assertion scoped to the primary communication device to the identity provider system from the primary communication device.

3. The method of claim 2, wherein the step of communicating the request for the user identity assertion scoped to the primary and secondary communication devices to the identity provider system includes communicating the user identity assertion scoped to the primary communication device and a single sign on session cookie from the primary communication device to the identity provider system.

4. The method of claim 2, wherein the step of communicating the request for the user identity assertion scoped to the primary and secondary communication devices to the identity provider system includes communicating the user identity assertion scoped to the primary communication device and a request for an extension assertion from the primary communication device to the identity provider system.

5. The method of claim 4, wherein the user identity assertion scoped to the primary and secondary communication devices includes the user identity assertion scoped to the primary communication device and the extension assertion.

6. The method of claim 2, wherein the step of establishing the collaboration between the primary and secondary communication devices is performed after the step of communicating the request for the user identity assertion scoped to the primary communication device from the primary communication device to the identity provider system.

7. The method of claim 1, wherein the step of pairing the primary and secondary communication devices is performed before the step of communicating the request for the user identity assertion scoped to the primary and secondary communication devices to the identity provider system from the primary communication device.

8. The method of claim 1, wherein the step of communicating the request for the user identity assertion to the identity provider system from the primary communication device includes communicating a primary communication device identifier and/or communicating a secondary communication device identifier to the identity provider system.

9. The method of claim 1, wherein the user identity assertion is implemented in an identity token.

10. A method for issuing a user identity assertion scoped to one or more communication devices, wherein the user identity assertion enables the one or more communication devices to access an application system, comprising:
receiving a request for the user identity assertion scoped to one or more communication devices from a first of the one or more communication devices, wherein the one or more communication devices are in collaboration with each other;
authenticating the first communication device;
generating the user identity assertion scoped to the one or more communication devices;
communicating the user identity assertion scoped to the one or more communication devices to the first of the one or more communication devices, wherein the first of the one or more communication devices is configured to communicate the user identity assertion to the one or more communication devices to the one or more communication devices; and
wherein the user identity assertion comprises an identification of the primary and the secondary communication devices, and also comprises a trust level for the primary and the secondary communication devices.

11. A apparatus for sharing a user identity assertion between a primary communication device and a secondary communication device, wherein the user identity assertion enables the primary and secondary devices to access an application system, comprising:
a collaboration module configured to pair the primary and secondary communication devices;
a request module configured to generate a request for the user identity assertion scoped to the primary and secondary communication devices;
a first interface configured to communicate the request for the user identity assertion scoped to the primary and secondary communication devices to an identity provider system and is further configured to receive the user identity assertion scoped to the primary and secondary communication devices from the identity provider system;
a second interface configured to communicate the user identity assertion scoped to the primary and secondary communication devices to the secondary communication device; and
wherein the user identity assertion comprises an identification of the primary and the secondary communication devices, and also comprises a trust level for the primary and the secondary communication devices.

12. The apparatus of claim 11, wherein the request module is further configured to generate a request for a user identity assertion scoped to the primary communication device.

13. The apparatus of claim 12, wherein the request for the user identity assertion scoped to the primary and secondary communication devices includes the user identity assertion scoped to the primary device and a single sign on session cookie.

14. The apparatus of claim 12, wherein the request for the user identity assertion scoped to the primary and secondary communication devices includes the user identity assertion scoped to the primary communication device and a request for an extension assertion.

15. The apparatus of claim 14, wherein the user identity assertion scoped to the primary and secondary communication devices includes the user identity assertion scoped to the primary communication device and the extension assertion.

16. The apparatus of claim 12, wherein the collaboration module is further configured to pair the primary and secondary communication devices after the first interface communicates the request for the user identity assertion scoped to the primary communication device to the identity provider system.

17. The apparatus of claim 11, wherein the collaboration module is further configured to pair the primary and secondary communication devices before the first interface communicates the request for the user identity assertion scoped to the primary and secondary communication devices to the identity provider system.

18. The apparatus of claim 11, wherein the first interface is further configured to communicate a primary communication device identifier and/or communicate a secondary communication device identifier to the identity provider system.

19. The apparatus of claim 11, wherein the user identity assertion is implemented in an identity token.

20. A system for issuing a user identity assertion scoped to one or more communication devices, wherein the user identity assertion enables the one or more communication devices to access an application system, comprising:
an interface configured to receive a request for the user identity assertion scoped to one or more communication devices from a first of the one or more communication device, wherein the one or more communication devices are in collaboration with each other;
an authentication module configured to authenticate the first one of the communication devices;
an assertion module configured to generate the user identity assertion scoped to the one or more communication devices, wherein the interface is further configured to communicate the user identity assertion scoped to the one or more communication devices to the first one of the communication devices and wherein the first of the one or more communication devices is configured to communicate the user identity assertion scoped to the one or more communication devices to the one or more communication devices; and
wherein the user identity assertion comprises an identification of the primary and the secondary communication devices, and also comprises a trust level for the primary and the secondary communication devices.
